(19) United States
(12) Patent Application Publication
(10) Pub. No.: US 2018/0322037 A1
(43) Pub. Date: Nov. 8, 2018

(54) IMPERSONATION IN TEST AUTOMATION

(71) Applicant: Microsoft Technology Licensing, LLC, Redmond, WA (US)

(72) Inventors: Krishnan Thazhathekalam, Bellevue, WA (US); Khalid Mahmood, Redmond, WA (US); Sebastian Kohlmeier, Mountlake Terrace, WA (US); Anjali Muralidhar, Seattle, WA (US); James S. Luke, Bellevue, WA (US); Akshay Gandhi, Seattle, WA (US)

(21) Appl. No.: 15/586,697

(22) Filed: May 4, 2017

(51) Int. Cl. G06F 11/36

(52) U.S. Cl. CPC G06F 11/3688; G06F 11/3664; G06F 11/3684

(57) ABSTRACT

In some embodiments, the disclosed subject matter involves a system and method relating to automation test runs of a software build, where the test runs effect impersonating an audience and selecting optional features to test with the impersonated audience. The impersonated audience is associated with a software build having static features, and the test runs include optional features, where each optional feature may have more than one associated treatment. Each feature/treatment combination may be tested in a test scenario associated with the feature/treatment combination. New features may be dynamically exposed to a selected audience to assist in verification and test of the new features. Other embodiments are described and claimed.

### TECHNICAL FIELD

An embodiment of the present subject matter relates generally to software builds, and more specifically, but not by way of limitation, to test automation for software builds having dynamically selected features.

### BACKGROUND

Various mechanisms exist for testing software builds and new software versions. Configuration management systems are often used where a developer, or developer team, may check software modules in and out of the system. When a module or update is checked in, the module gets compiled and linked with other modules and features to build the final product.

As software systems become larger and more complex, and as marketing schemes with incremental level functionality become more popular, it becomes more and more difficult to test various versions of the software build. For instance, in a typical development environment, different teams work concurrently on different aspects of the entire system, including bug fixing and new features or enhancements.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating feature gates in software builds, according to an embodiment;

FIG. 2A illustrates various audiences of users and how an audience corresponds to a build version, according to an embodiment;

FIG. 2B illustrates the ring audiences to show conceptual concentric rings, according to an embodiment;

FIG. 3 is a diagram illustrating a build with selected flights or feature/configuration combinations, according to an embodiment;

FIG. 4A illustrates default behavior for lab automation, in an embodiment;

FIG. 4B illustrates audience support with static features enabled based on an audience selection, according to an embodiment;

FIG. 4C illustrates a feature override support for both a single treatment and multi-treatment, according to an embodiment;

FIG. 5 is a diagram illustrating a test environment for building and testing dynamic software with audience impersonation, according to an embodiment;

FIG. 6 is a flow chart illustrating a method for building an automation test run, according to an embodiment;

FIG. 7 is a flow diagram illustrating a method for dynamically triggering an automation job by impersonating an audience, according to an embodiment; and

FIG. 8 is a diagram illustrating an example of a machine upon which one or more embodiments may be implemented.

### SUMMARY

Some organizations may deploy a system, or software build, with different feature sets or operational parameters to different audiences or user populations. As new features are developed, the new features should be tested with each deployed version for each audience. However, a development team may be unaware of which features are being developed by other teams and how the features may interact for different user populations. Embodiments as described herein use feature gates, or hooks, in software application code to enable an application program interface (API) to utilize classes and objects for access to configuration parameters that define the operational state of optional features in the software build, at runtime.

The subject matter disclosed herein allows a test team to “A/B test” features with various client builds and for successive rings of audiences. In an embodiment, at each test phase, and at each ring, new features may be included with a baseline build for the audience associated with the ring. As a feature passes testing for an audience, that feature may be added to the audience baseline and then be tested as an optional feature for the next ring audience, until the feature is stable enough to be added into the final production baseline build (e.g., innermost ring). Features in the application code associated with, and included in a build, may be disabled at runtime, so that the feature is hidden to the end-user in the audience.

In existing systems, it is difficult to test the many dynamic features with features already added to the baseline of another audience, or ring, because a feature may not typically be promoted to a next ring audience until fully tested at the current ring. Existing systems typically cannot ship software builds with different features to different audiences due to the enormous effort required for quality testing. In the past, if a bug was found in a feature, it might force the developers to go back to the beginning of the test process and delay deployment for a significant amount of time, to back out the faulty feature. Embodiments described herein allow a test engineer or developer to impersonate an audience to enable testing of at least one optional feature with the baseline build for the impersonated audience. Impersonating the audience allows features to be tested with other features or baselines that are outside of the standard ring promotion procedure. For instance, in a development and testing paradigm that utilizes four successive rings of audiences, a newly developed feature may be tested at the innermost or most stable ring by impersonating that audience. In a typical lab test environment, the newly developed feature would normally only be tested at the outermost ring or audience, with other less stable features. Impersonation of an audience means that features, configurations, and treatments for the selected audience and channel are present in the software build. Any additional optional features, treatments, or filters to be selected may be included as override commands before the test run is built.

Embodiments as disclosed herein provide a system for automation management of a software build according to an audience impersonation, comprising a processor to execute automation build logic, the automation build logic configured to receive selected audience, build, and channel identifiers for a software build; generate the software build for an automation test using build configuration information to identify static features associated with the selected audience and an optional feature for inclusion in the software build, wherein the static features are dependent on a feature configuration information in a configuration database communicatively coupled to the processor; and generate at least one test scenario for the software build. A build configuration data store is communicatively coupled to the processor, the build configuration data store storing a data file that identifies test parameters associated with a target platform, architecture, the software build, selected audience, and the optional feature, wherein the test scenario includes at least one test run having a predefined combinations of features, as defined in the feature configuration information.

Other embodiments may include a method, means for performing acts of the method, at least one machine-readable medium including instructions that, when performed by a machine cause the machine to perform acts of the method, or of an apparatus or system for impersonating an audience in an automation test lab to manage and test software quality in a software build for the impersonated audience.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to impersonating an audience during test automation. In at least one embodiment, feature(s) that are scheduled to be included in the build for one audience may be tested with the features associated with a different audience. The feature sets in the test may be selected based on an impersonated audience for testing with baseline, and non-baseline features associated with the impersonated audience. Impersonation will be discussed in more detail, below.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

The subject matter disclosed herein allows a test team to “A/B test” features with various client builds. In an embodiment, a feature is tested for a specific audience with other features associated with the specified audience. Effects of rolling out new features may be isolated with respect to the base build, by successively testing with smaller sets of new and stable features. In existing systems, it is difficult to test the many dynamic features on top of a client build. Existing systems typically cannot ship software builds with different features to different populations due to the enormous effort required for quality testing. In the past, if a bug was found in a feature, it might force the developers to go back to the beginning of the test process and delay deployment for a significant amount of time, to back out the faulty feature.

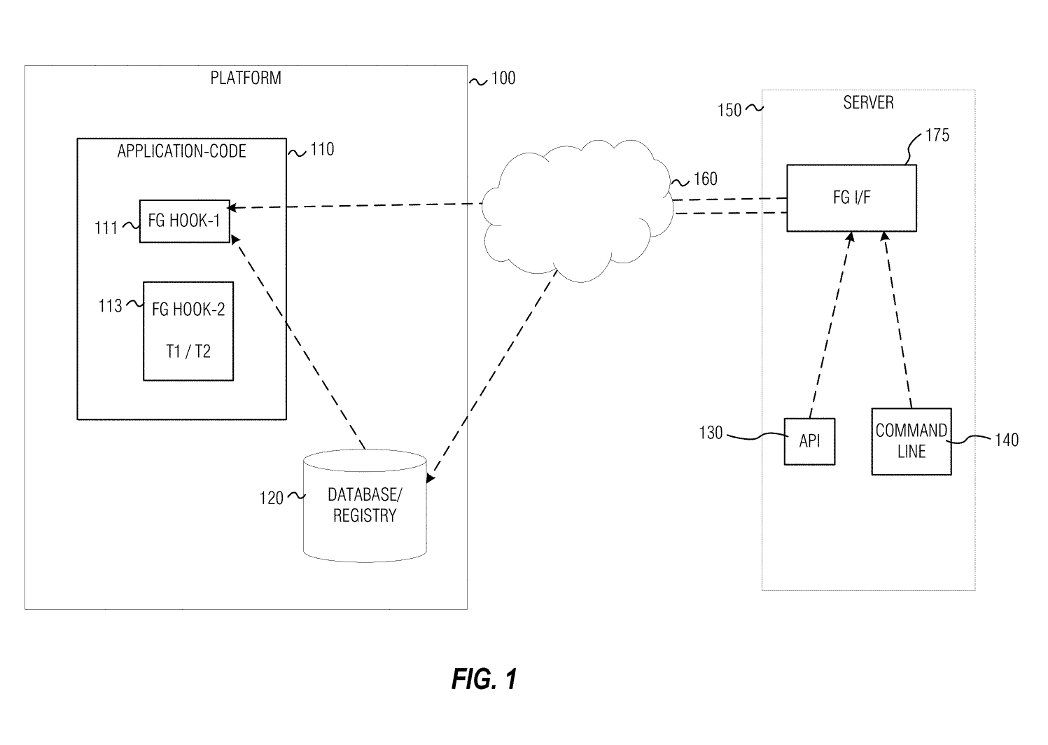

FIG. 1 is a diagram illustrating feature gates in software builds, according to an embodiment. A platform 100 is shown having an installed application 110. The code for application 110 may include feature gate code 111, 113. As described herein, application code may have software hooks in the code that define operation of a feature based on externally defined parameters. These software hooks may be referred to as “feature gates,” because a feature may be gated on or off, and/or specific parameters may be gated to A/B values. In an example, application code 110 may include feature gates 111 and 113. A feature gate is an internal on/off gate, or A/B gate. In some instances, the gate may turn the entire feature on or off. In another example, the gate may define a specific parameter for runtime, such as a timing of fast or slow for an operation (e.g., 5 ms vs. 100 ms), or something as simple as color for an alert (e.g., red vs. black). In an example, feature gate 113 may also be associated with two optional variables, or operational parameters. These operational parameters may be referred to as treatments. In this example, feature gate 113 may have two possible treatments, T1 and T2. For software that is heavy with user experience or user interfaces, successful testing may be dependent on user perception rather than just faults. For this type of system, there may be hundreds of dynamic features that may be on or off at varying percentages. This type of testing requires a more complex environment than previously available in traditional software development and test environments.

In an embodiment, source code 110 for a software build may include feature gates 111, 113 for specific features. The code may include a class used for the A/B testing. In an example, the A/B testing class is the AB_t class which represents an object having an associated value, where the value may differ depending on various client, or platform properties. The values may be determined by the Scope and feature settings for the user/client. In an example, features relate to A/B values and treatment codes. Scope may relate to things such as audience, language or other configuration settings. The context for features, A/B values, platform, etc. that define a specific build may be referred to as a flight. A Scope may be defined by code/binary in the software build. A flight, on the other hand, may be defined when a configuration is received from the Web portal, or configuration system. A vector of value-Scope pairs allows for defining values to be used for specific Scopes. A Scope value may be used in the absence of any dynamically configured value for this object. If the condition specified in a given Scope is satisfied, then the object holds the corresponding specified value.

In an embodiment, a Scope may be evaluated from left to right, and therefore the object may hold the value specified in the first Scope that satisfies the specific condition. Left to right refers to the vector of value-Scope pairs that allows for defining values to be used for specific Scopes. In absence of a dynamically configured value for a feature, the pairs may be evaluated in this vector from start to end (e.g., left to right), and the first pair for which the Scope evaluates to true, the corresponding value is assigned to the feature. A default value may be used when none of the Scopes satisfies the condition. Each AB_t object may include a feature name to be matched with flights received by the client. These flights may either send the entire object that the AB_t object holds, or the flight may send a reference to one of the predetermined values specified within AB_t. In an example, a flight, or selected combination of features, may be consistent throughout a session. In other words, features in the software may remain active/inactive until a new session for the software application is begun. In an embodiment, the AB_t class is effected using an application program interface (API).

Constructors may be used in the code 111, 113 to construct an object of type T in the AB_t class, where value of the object of type T may be configured dynamically. A default value may be used if there is no configured value. The constructor may include parameters such as feature-name, default-value, possible-values, Scope-values, etc. An operator T( ) may return a value used to get the value associated with the specified feature/setting. This value may vary depending on conditions within the current session. In an example, conditions may include feature override, registry override, server side configurations, Scope/value pairs, or others. Various types of overrides may be available based on where the override is set, e.g., client, server, audience-based, etc. In an example, a feature override may be based on an API, which may override a feature in a test framework. A registry override may apply when a developer sets an override in a registry key to override a feature value and test different behavior. A server side configuration may be the flight configuration system on the server side.

In an example, when various conditions are mutually exclusive, the precedence order of these conditions may be pre-defined. Other classes may be available to provide different audiences or feature sets based on other criteria. For instance, a Boolean class may be available to simplify the objects that do not require A/B testing.

In an embodiment, the new features are included with the compiled and linked software for the base build. However, the feature gates 111, 113 may be applied to make a feature either on or off or correspond to one parameter or another, as discussed above. In traditional software development, features that were not yet ready to be installed in the final deployment may have been included as a stub code. Various techniques for stubbing a function or module have been widely used by programmers for many years. However, code that has been stubbed out may not be tested until the full code is compiled and linked with the base build. Thus, testing these features manually by stubbing the code, and recompiling each time a stub is inserted or omitted, is time intensive and prone to delays in schedule when there are bugs found.

A software build may use defined parameters to dynamically configure the feature gates in several ways. In an embodiment, when the software build is installed on the platform 100 the feature gate parameters may be stored in a database or system registry 120 on the platform 100. In an embodiment, the platform may be a device having an architecture that does not use a system registry. In this example, the database may emulate a system registry, or retrieve feature and configuration for a database communicatively coupled to the platform. The database may be directly connected, or accessed over a network. The software may determine whether the features are exposed (e.g., enabled) at runtime, by retrieving the parameters from the database/registry 120. In an embodiment, the features may remain static during testing for a specific audience, as defined by parameters stored in an experiment and configuration system, as described below. Each feature may have a default value in code. Feature gates and AB_t objects may have a default value in code/Source Depot in case access to a Web portal (e.g., network accessed database) is unavailable. Overrides may be present in the registry, or local database 120, so that a value may be returned when called. The values retrieved from network database and registry may take precedence over the default values stored in code.

In an embodiment, the parameters may be sent to the platform 100 using an application program interface (API) 130 or a command line interface 140. In an embodiment, the command line interface 140 or API 130 may provide feature gate overrides, or flight information to a feature gate interface 175. The feature gate interface 175 may reside on server 150 and take the command line or API models and help build the database/registry 120. The feature gate interface 175 may also act as a Web portal for API calls in the application code 110, and accessed over network 160, to provide configuration and flight information during runtime. The platform 100 may communicate with server 150 via a local or public network 160. In an embodiment, the configuration parameters may be stored in database/registry 120 during installation of the application on a test machine. In an embodiment, feature configuration parameters may be stored in the database/registry 120 during installation, but may be dynamically overridden during runtime based on a platform, user, audience, or channel designation to be used in the feature gate 111, 113. In an embodiment, feature gate parameters may be retrieved from the server 150 (e.g., from the feature gate interface 175) during launch, runtime or installation. If the server 150 is unavailable, default parameters store in the database/registry 120 may be used.

The concept of folding in one or more new or updated features to a stable base software build may be referred to herein as “feature rollout.” Various feature rollouts may be dynamically disabled to fix an issue (e.g., bug or poor user experience) found in testing and may result in little or no delay in the release of the client build. An embodiment, as described herein, provides a process that allows the development and testing teams to assess if an issue was due to the base build (which may require a code fix and a new build, including a new test cycle), or due to one or more feature rollouts (which may be quickly mitigated by turning them off). In an embodiment, a process is used to segment an audience of users into a user population that receives the base build only, and at least one other user population that would receive the base build including one or more feature rollouts. In an example users with an audience A may be segmented into two populations, one to receive the baseline build and one to receive a build that includes optional features. By comparing the two segments or populations, the effects of feature rollouts in the non-baseline build may be isolated and decoupled from the base build release, when necessary.

In an embodiment, source code 110 for the software build may be implemented in a specific language such as C# for various platforms and operating systems. Feature gate APIs 130 may also be implemented in C# for ease of interoperability. For instance, source code may be the same for a platform 100 running a Microsoft® Windows® operating system (OS), a mobile device running Android™ OS, or a device running Apple® iOS® or MacOS™ OS. In an example, for instance, the Android™ OS application user interface (UI) components make use of native platform capabilities and thus, they may be implemented in Java® code. A Java® wrapper layer may be used for an implementation of Feature Gates 111, 113 for Android™ devices. In an embodiment, the Java® wrapper layer internally may call into C# Feature Gate APIs 130 using Java-Native Interface (JNI).

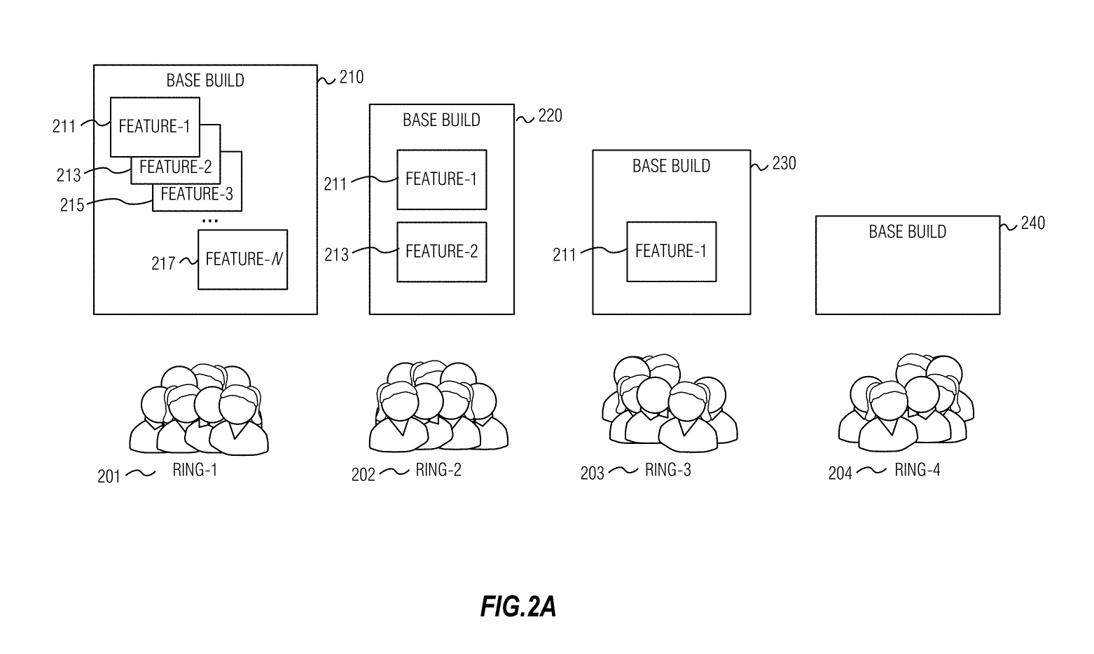

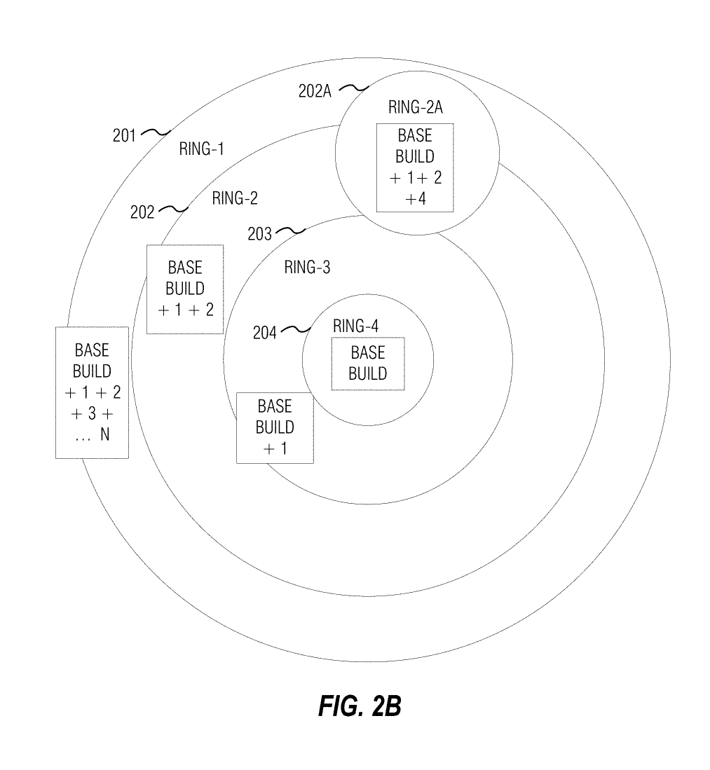

In an embodiment, a software system may be deployed to different populations, or audiences, based on the sophistication or familiarity that the users of the audience have with this software system. An audience may be referred to as a “ring.” FIG. 2A illustrates various audiences of users and how an audience corresponds to a build version, according to an embodiment. In an example, a system may be deployed to four rings, ring-1 201, ring-2 202, ring-3 203, and ring-4 204. In the illustrated example, ring-4 204 represents the audience of end-users that receive the base build that has been fully tested and is operationally stable 240. Ring-1 201 represents a user audience of the developers who may be creating any of features 1-N (211, 213, 215, 217) and may need to test their team's feature with the base build and with other teams' new features 210. Depending on the size of the software system and how many different sets of users are available to test various features, an enterprise may have more than, or fewer than, the four rings, or audiences, as illustrated. In this example, ring-2 202 represents a ring that is to receive the base build plus features 1 and 2 (211, 213) as build 220. This ring may correspond to a larger group that is internal to the development team or enterprise, so that discovered bugs have less of a risk associated with end-users. In some environments, a subset of the end-users may choose to opt in to receive advance deployment of new features, and assume the risk that there are bugs. In this example, ring-3 203 represents an audience of end users that have opted in to advanced deployment. The build for ring-3 203 may include the base build and feature 1 (211) as build 230.

In an embodiment, test engineers or developers may impersonate an audience, or ring, in the test lab, in order to test new features for that audience. In this context, impersonation means that the test engineer sets up a test run as if the build were associated with the impersonated audience. Impersonation allows features to be tested, or exposed, in builds that would by default not include that feature. For instance, if a feature has not been fully tested in ring-1, it should not be included in ring-2. However, a development team may wish to test their feature only with features that have already been promoted to ring-2. In this case, the test engineer may select ring-2 as the audience, thereby impersonating audience ring-2, and enable the desired feature, thus overriding the usual test defaults for specific audiences. This option is especially useful in early stages of testing. For instance, during testing in ring-1, so many new and unstable features may be enabled that it may be difficult to ascertain why a specific feature is failing. By impersonating a ring-2 audience for testing the optional features, a development team may test their new feature with a more stable build.

FIG. 2B illustrates the ring audiences to show conceptual concentric rings, according to an embodiment. FIG. 2B illustrates the ring audiences as shown in FIG. 2A (201-204), and also includes an additional ring-2A 202A. In this example, ring-2A 202A includes the base build and features 1, 2 and 4. It may be seen that ring-4 204 is the smallest concentric ring, and excludes features that have not been fully tested. This smallest ring-4 204 is designated the base build that will be sent to the general end user audience. The outermost ring, ring-1 201 may include many optional features under test and experimentation. As the ring gets smaller and closer to the base build, the code and features are expected to be more stable and tested. Audiences may be thought of as being at various stages of the development lifecycle, with the innermost ring being the final and most stable stage.

In an example feature 4 may not be ready to integrate into the ring-2 build, which includes optional features 1 and 2. A test engineer may impersonate the audience for ring-2 202 which includes the base build and features 1-2 and test this build with feature 4 enabled. This combination results in conceptual ring-2A 202A, even though ring-2A is not an actual user audience with a corresponding build. Thus, testing may be performed for an audience that would not normally have existed in the lab, and developers may test feature 4 for an audience outside of the normal test cycle. This allows the developers to identify bugs or issues with the new feature code before the feature is deployed to end users, at any level.

In an embodiment, feature rollouts at every stage of the development lifecycle have lower probability of having fatal errors because the features are validated at each ring in both an on and off state. A feature may not be promoted to a next innermost ring until it has been validated in an outer ring. Integration and development is enhanced because teams have the ability to test with features that have not yet been completely rolled out. In a traditional development and test environment, each team would include their feature in the base build and then test to see if that build is stable. However when there are dozens of teams working on various features, there is no way in the traditional model to test a feature against a different feature that has not yet been integrated into the build. In an embodiment, a development team is able to test their new feature as if they were operating at a different ring, e.g., by impersonating an audience. For instance, as in the example above, if the development team for feature 4 wants to know if their feature will work with features 1 and 2 they may include the feature in ring-2A 202A, an impersonation of the audience for ring-2 202. If the development team working on feature 1 determines that the feature has been tested enough with the various other features in ring-1 201 and is fully stable, feature 1 may be added to the next ring, ring-2 202, then ring-3 203, and so on. But in traditional testing, a development team could not test their new feature with features in another ring, or audience, until they had been promoted to the targeted audience ring. Ultimately ring-4 204, referred to as the base build, is the previous release version plus all fully tested stable features that have been promoted through the rings.

There may be several channels of deployment to various audiences. For instance, an end user in the audience corresponding to ring-4 204 may be scheduled to receive the base build. Some end-users may prefer a different update schedule. For instance, one channel of users may prefer a monthly update with bug fixes and new features. Another channel of end-users may prefer the same build but only every six months, for more stability. Other channels may be related to validating feature readiness. For instance the term “fork” as used herein may represent the channel that includes feature rollouts that are ready to go all the way to a production system, or end-users. Before a feature is ready to be in the fork release, it may conceptually correspond to a channel referred to DEV, for a development channel. Both audiences and channels may be defined during test automation, to identify which build is being tested. In an example, both an audience designation and channel designation may be used to define a particular build, in addition to other filters such as language, platform, architecture, feature overrides, etc. In an embodiment, selecting a particular build number, audience and channel may uniquely identify the software build to deliver. The software build may then allow overrides for various features and other filters or parameters to create a second uniquely identified software build (e.g., identified by build number, audience, channel, optional features, filter overrides, etc.).

As discussed above, a developer may wish to include many new features in a fork release, where the features may be developed by disparate teams. Testing a feature with every permutation of other features is often neither desirable, nor feasible. However, a development team may wish to test their new feature with a build designated for a select audience, and with features to be rolled out to that audience. In a usual test scenario, a team's feature may be tested in ring-1 201 and be rolled out only with the features gated on for the ring-1 audience. In an example, the development team may want to test their new feature with features to be rolled out to ring-2 202. In this example, the ring-2 audience may be impersonated in the lab to test the new feature with audience ring-2, even if the feature is not ready to be promoted to ring-2.

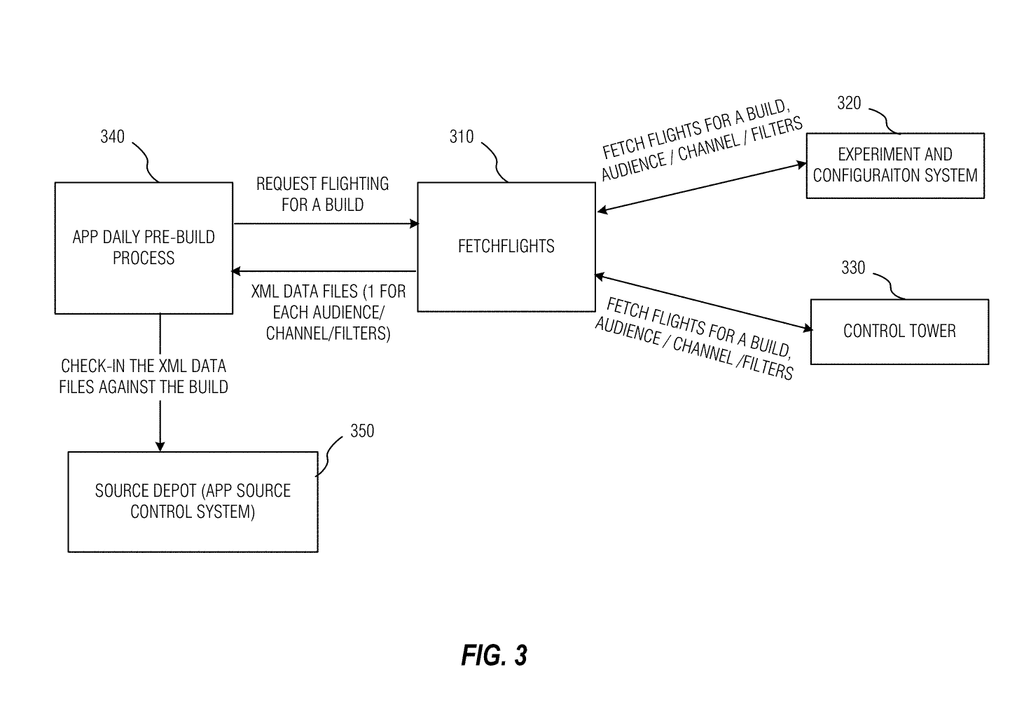

FIG. 3 is a diagram illustrating a build with selected flights or feature/configuration combinations, or parameters, according to an embodiment. In an embodiment, XML, or other data files, containing flight information (e.g., feature combination, platform, audience and channel information, other filtering. etc.) may be applied to different builds using an automation build process, module or logic. In an example, the base build may be re-run on a daily, or other periodic basis to include fully tested features or to exclude features that have failed testing. Other builds may be deployed for selected audiences, with different active features, and specific to different platforms and/or operating systems, and architectures. Before deploying a build to the target audience, the build may be tested in an automation test run in a test environment.

In an embodiment, automation test runs may be performed on a daily, or other periodic basis using the automation build process. As part of the daily pre-build process 340 for an application, an engine, or software process, herein referred to as FetchFlights engine 310, may be invoked by providing it an upcoming build number/identifier as a parameter. In an example, there may be two sources from which the engine 310 fetches the flight information: either the experimentation and configuration system (ECS) 320 or the control tower (CT) 330. FetchFlights engine 310 may use a representation state transfer (REST) compliant API to fetch the flight information for the given build number from ECS 320 or CT 330 for different audience/channel combinations. In an example, ECS 320 may be used by a development team and CT 330 may be used by test automation engineers. The configuration system (e.g., ECS or CT) may be specific to an engineering team and have custom configurations defined that are specific to that team. In an embodiment, there may be one, two, or more than two configuration systems (320, 330) coupled to the server and each configuration system may be used for different testing purposes, or by different teams.

After retrieving the flight configurations from the server, FetchFlights engine 310 may segregate the data on different parameters such as platform, architecture, and application. The features that are not to be included may be filtered out or have their allocation percentage set to zero. When a feature is filtered out, the featureGate is gated off; therefore, the code path to enable the feature is never executed. In an embodiment, the FetchFlights engine 310 may generate an XML, or other data file, for each valid audience/channel combination, or test parameters for automation testing. It should be understood that file formats other than XML may be used to transfer the information to the pre-build process 340. In an example, the XML file may use a naming convention such as flights.<audience>.<channel>.xml to distinguish the specifics of each build, for instance for feature combinations (e.g., flights), audience and channel.

The XML files generated by FetchFlights engine 310 may then be checked into the Application Source Control system (Source Depot) 350, as part of the pre-build process. Source Depot 350 may help manage version control. The Source Depot 350 may be used as a central repository for the product source code. Checking in the XML file allows test runs to access the information, and may tie the feature information with the build by storing the product code in the XML file. Developers may use the ECS/CT portals 320, 330 to change the feature setting for a given build. However, this may at times result in inconsistency in automation runs because different runs against a given build may include different feature settings. This may make debugging extremely difficult. In an embodiment, the feature settings corresponding to a given build may be checked in to the source control system so that all automation runs against that build use the same feature settings.

In a typical automated test environment, testing may be performed on builds that have been defined for a particular audience, channel and build, where the build is to be deployed to users in the audience. The ability to impersonate an audience during a test run allows the test engineers to build tests and configure test machines having combinations of features, where new features under development may be tested with other features that have already been tested and are believed stable in builds for a different audience, or ring, than the new feature under development and test.

In an embodiment, a test engineer may select a channel and audience in a command line to commence test automation. In an embodiment, command line parameters for a batch file (e.g. lab.bat) may control the state of features, settings, and featureGate objects in the application code. In other test environments, these objects may have been set by a direct call from the client to a configuration service. By moving the identification of settings and configurations to a command line these objects may be configured consistently throughout a test run. The command line usage may also allow the test engineer to reproduce previous runs using the same feature rollout configuration. Relying on flight data in the configuration system to configure the features may be harder to track when changes are made to an underlying audience configuration. However, the command line option may be saved for future use and reference.

In an example, a convenience API may be used to return configuration information to match given parameters. For instance, an XML command line:

config.edge.appln.com/config/v1/OAuto/0.0.0.0?&Channel=
CC&Audience=RING-3

may return every feature rollout associated with a current channel (e.g., CC channel) and a ring-3 audience, regardless of how other filters are set. In this example, a configuration would not be returned if the API call does not specify a filter that the configuration has set. In another embodiment, an API may return all of the feature rollouts matching the given parameters, irrespective of whether the rollout has additional filters set.

In an embodiment, a command line with separated feature-value pairs may be used for a particular run, such as:

lab_run -set featurevaluepairs=″<featureName1>:<value>,

<featureName2>:<value>,..”

where the featureName-n represents the nth feature and <value> represents a value for feature n, such as on/off, A/B, etc. For features that have a string value, or other non-Boolean value, a command line may include the value type as well as the value. For instance, a vale pair may be expressed as <featureName>:<value>:<valuetype> as in “ApplicationName:feature-n:string.”

In an embodiment, the FetchFlights engine 310 may perform the REST API calls once per day. The command line interface used by testers may make use of the information retrieved from the FetchFlights result rather than conducting a new REST API call prior to each test.

In an embodiment, the API may be invoked from a Tasklib. Tasklib is a library in C# that may be used for end-end automation testing (it does test infrastructure setup, test execution and test cleanup). Each application team may have its own version of Tasklib. APIs in C# (e.g., SetFeatureOverrides and RemoveFeatureOverrides) may be invoked from the Tasklib to set feature overrides in automation. The overrides set using this approach may be applicable only for a specific test rather than all the test scenarios. In contrast, a command-line approach may set feature overrides for all test scenarios in a test session. Any overrides set using the Tasklib method may take precedence over the overrides set using the command-line parameters. For instance, a function may be invoked to set feature overrides that is defined in a configuration setting library. This option may use a dictionary of the featureName and value pairs as the parameter. In an example, a Tasklib invocation may use a syntax such as:

SetFeatureOverrides(IDictionary<string, int>

featureNameValueList).

In an example, a feature override may be selected for only a specific application, and not the entire product build. For instance, the following API function invocation may be used to override application appName:

SetFeatureOverrides(IDictionary<string, string>

featureNameValueList, bool isForAllApp, MATE2.AppName appName),

where isForAllApp should be false and the appName should be the software application for which the test engineer desires to add the override (e.g., MATE2.AppName.PPT override). For instance, if isForAllApp is set to false, the feature overrides may be applied only to the application specified using the appName parameter. The other applications may use static Scopes to evaluate the value of the corresponding features. The API that uses an int value-type may be used for overriding Boolean FeatureGates. The only values that may be used with a Boolean type are 0 (e.g., False) and 1 (e.g., True). To override a FeatureGate with any value-type, an API using a string value-type and featureNameValueList may be used. This API may be used to override FeatureGates with Integer, String, Boolean and Index type values. In an example, the dictionary key may be the featurename and the value may be in the following format value:type, where “value” is the feature value to override and the supported values for “type” are Integer, Boolean, String and Index. The API using a string value-type is a more flexible call that allows for multiple value types.

In an embodiment, if the feature/value pair is not provided as a lab test command-line parameter or as an argument to SetFeatureOverrides, the default features fetched from configuration system for that audience/channel combination may take precedence. If a feature/value pair is provided as a lab command-line parameter but not provided as an argument to SetFeatureOverrides, the value provided as the lab test command-line parameter may take precedence for that particular lab, or test run. If a feature/value pair is provided as a lab command-line parameter as well as an argument to SetFeatureOverrides, the value that is supplied through the SetFeatureOverrides API may take precedence for that particular lab run.

In an embodiment, an automation test run may be triggered with the following:

lab_run-set “audience=<Desired-Audience>”.

For this run, all features with audience filter set on for the <Desired-Audience> in the configuration system 320, or CT 330, and build filter matching the checkpoint, or build number, against which the run is triggered, are to be applied for that run. In the case when no audience filter is set, it may be assumed that the feature is applicable for all audience rings, and may be applied to the test run. In an example, when no audience is impersonated, only features targeting Audience Automation may be applied to the test run. Features may be further segregated based on platform, architecture and application for each scenario. For instance, if the scenario configuration corresponds to platform=Win32 and architecture=X64, only the features matching the corresponding platform/architecture values may be applicable for that particular scenario run. In an example, a test run may apply to a specific application. In this scenario, any features specific to the application may be applied. In an embodiment, a percentage allocation may be associated with a feature for A/B testing throughout an audience, where a percentage of audience members are exposed to the feature and some percentage of audience members have a dark, or disabled feature, instead. If the selected channel defines percentages, then all features with allocation percentage greater than zero may be exposed or enabled for the test run. Hence, even if a feature rollout is targeting only 33% of the users in an audience, the feature may be exposed in 100% of automation runs, provided there is a match for the other filters. In an embodiment, for impersonated and automation test runs, parameters/filters retrieved from configuration system 320 or control tower 330, other than the audience, channel, build version, platform, architecture and application, may be ignored. For example, if a feature has language filter set to ja-jp (e.g., Japanese), the language filter may be applied for scenarios targeting language en-us (e.g., American English), also, as long as there is match for the filters that are honored. In some cases, only certain filters such as audience, channel, build version, architecture, and application name may be relevant. Matching a filter means that the filter value is a valid value for the feature to be turned on. For instance, if the feature is meant for a specific application A, and the test is running application A, then the filter may be matched. Some filters, such as language, may be disregarded for the test run. In an example, the behavior in an automation run may be very similar to a build of a deployed client application.

In an embodiment, new features may be developed that must be exposed for other specific features to be tested. In other words, some features may be dependent on other features. A feature may be made statically exposed via a featuregateoverride parameter. In an embodiment, this parameter may be an internal API call used within test run code to turn on a feature. In an example, the feature may be turned on programmatically during runtime without input from the Web portal or configuration system, command line, or the XML file that gets checked into Source Depot. In an example, the test engineer may be notified by the development team that feature A must be exposed for an automation run with feature B. In an example, dependent features are turned on together manually using feature value pairs. The dependency may also be identified in the configuration database in a flight, to automatically expose the feature depended upon.

In an embodiment, when the test team identifies a dependency between or among features, for instance that feature B fails when tested without feature A, this dependency may be recorded and saved in the configuration system or control tower as a flight. In another example, the dependency may be performed as a manual override.

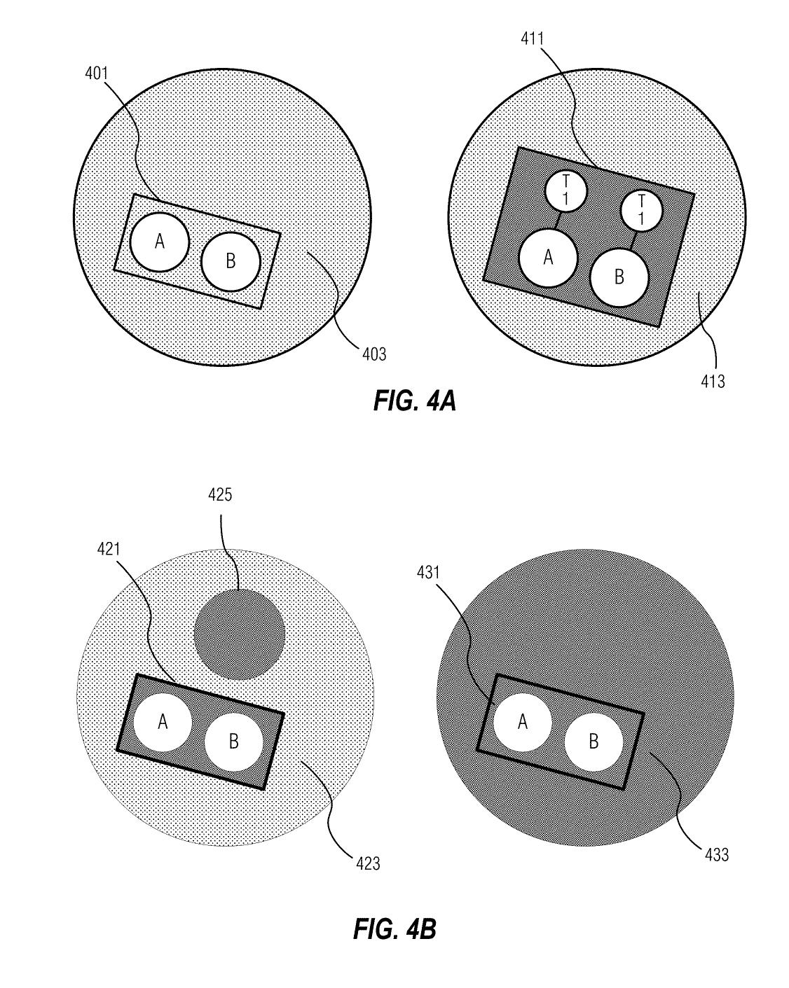

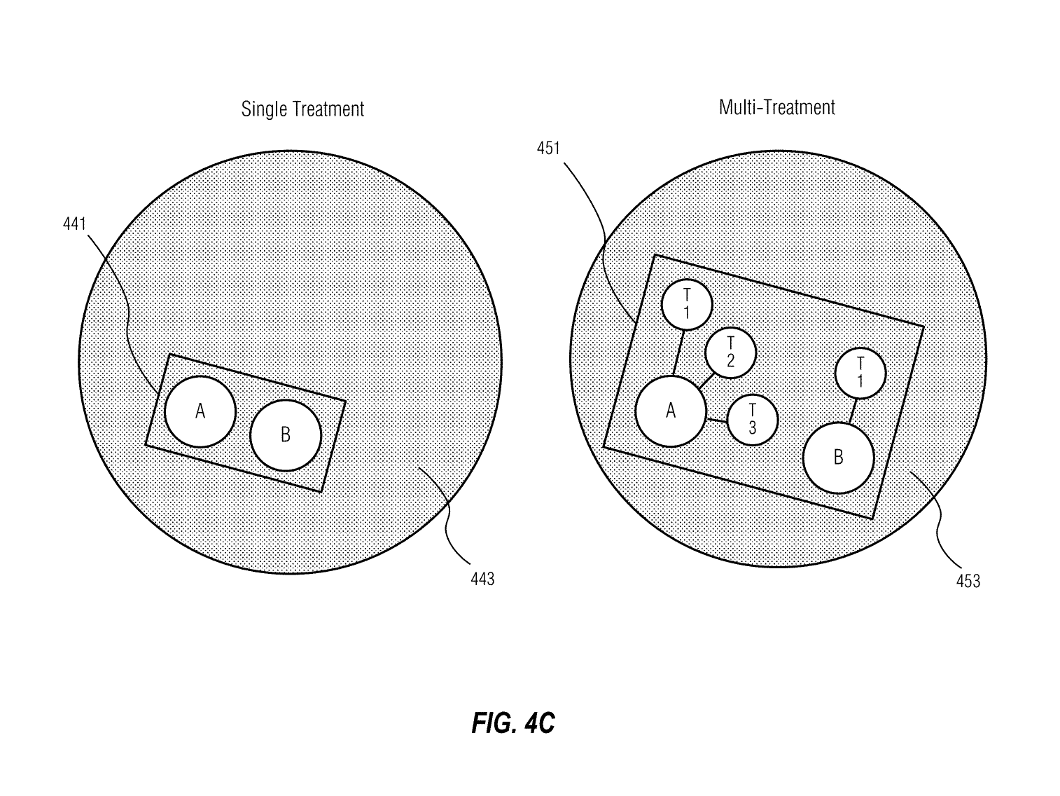

FIGS. 4A-C are diagrams illustrating testing of features for specific audiences, according to an embodiment. In an embodiment, dynamic feature fates may be disabled by default for a specific audience. Thus, the feature gates must be turned on for specific automation test runs. In an automation audience run, features may be exposed, or enabled by default. A feature gate may be exposed based on parameters or filters set at the time the automation run is invoked. For instance, a feature may be turned on by a command line, XML file, or Tasklib. Tasklib is a TSO command processor. TSO (time sharing option) and ISPF (Interactive System Productivity Facility) are software environments that may be used to by test engineers to create, store, print and delete data sets and to submit and examine test jobs. In an embodiment, the default behavior of a lab automation test run may include dynamic features that have been shipped to production audiences, as a baseline. An automation test run may activate all features exposed to a specific audience using a command line run or Tasklib option to enable testing of one or more features against all other features in the application code base that are exposed to that audience. This capability may enable a teams to complete a regression test against the audience/ring before promoting their feature to that ring.

In an embodiment, a test automation run may selectively test multiple combinations of dark deployed features (or treatments against) to test dependencies and interaction effects with the option to specify an audience. In this context, application code includes the code for the dark deployed feature, but the feature code is gated off, so it will not execute at runtime. Features to be activated for a given lab automation test run may be previewed before start of the test run. Formalizing the selection and test automation of selected features to an impersonated audience allow issues to be reproduced by re-running the automation run with the same settings (e.g., same command line, XML file, Tasklib). Failures may be further evaluated by identifying which features were activated in a specific lab run.

In an embodiment, in a automation test example for a specific audience, the default behavior for lab automation may be illustrated in FIG. 4A. In an example audience, all dynamic features may be disabled, as indicated by circle 403. Dynamic features A and B are made dark 401. In other words, the tested code includes the features A and B, but they are gated off. Features A and B with treatment T1 411 may be tested in the automation run by overriding the dark default, with other dynamic features disabled 413, for the selected audience.

FIG. 4B illustrates a current audience support with static features enabled 425, based on an audience selection. Features A and B are gated on with an override 421, but other features are still disabled 423. A new audiences impersonation support may include dark feature overrides 431 and static and dynamic features enabled based on audience selection 433. In an examples, specifying a channel C1 and audience A1 (herein, C1/A1 combination) may result in all features exposed to A1 to be activated 433. Features that are not active in C1/A1 may not be activated. In cases where multiple configurations are available for a single feature rollout, the system may select the configuration that is exposed to the highest priority configuration for the build that is being tested, if there is an intersection between configurations (i.e. the multiple configurations apply to a single client based on audience/build filter selection). For instance, if there is a configuration for both audiences ring-3 and ring-4, one from the command line and one from the configuration system, the configuration for ring-4 may be selected as an innermost ring, or higher priority audience.

FIG. 4C illustrates a feature override support for both a single treatment and multi-treatment, according to an embodiment. In an example, features for a lab run for a subset of filters including audience, channel, platform and architecture may be selected. Filter support for other lab automation filters may be selected, as needed. In an embodiment, a team may override or edit settings, for instance, using a text file or command line parameters. To test features with an audience that has not yet deployed the feature, impersonation of an audience provides A/B experimentation capabilities. For instance a single treatment of a feature is shown for features A and B 441, as a dark feature override, where other dynamic features are disabled 443. A feature may have multiple treatments 451. In an example 451, feature A has possible treatments T1, T2 and T3. Feature B has treatment T1.

To test multiple treatment combinations in an automation test run, the command line or XML file and Tasklib feature activation capabilities may be extended to enable activation of the dynamic feature and A/B experiment treatments associated with permutations as sequential lab runs. For instance, testing features A and B with treatments as identified in 451 may include three individual and sequential runs. The first run may include feature A:T1 and feature B. The second run may include feature A:T2 and feature B. The third run may include feature A:T3 and feature B.

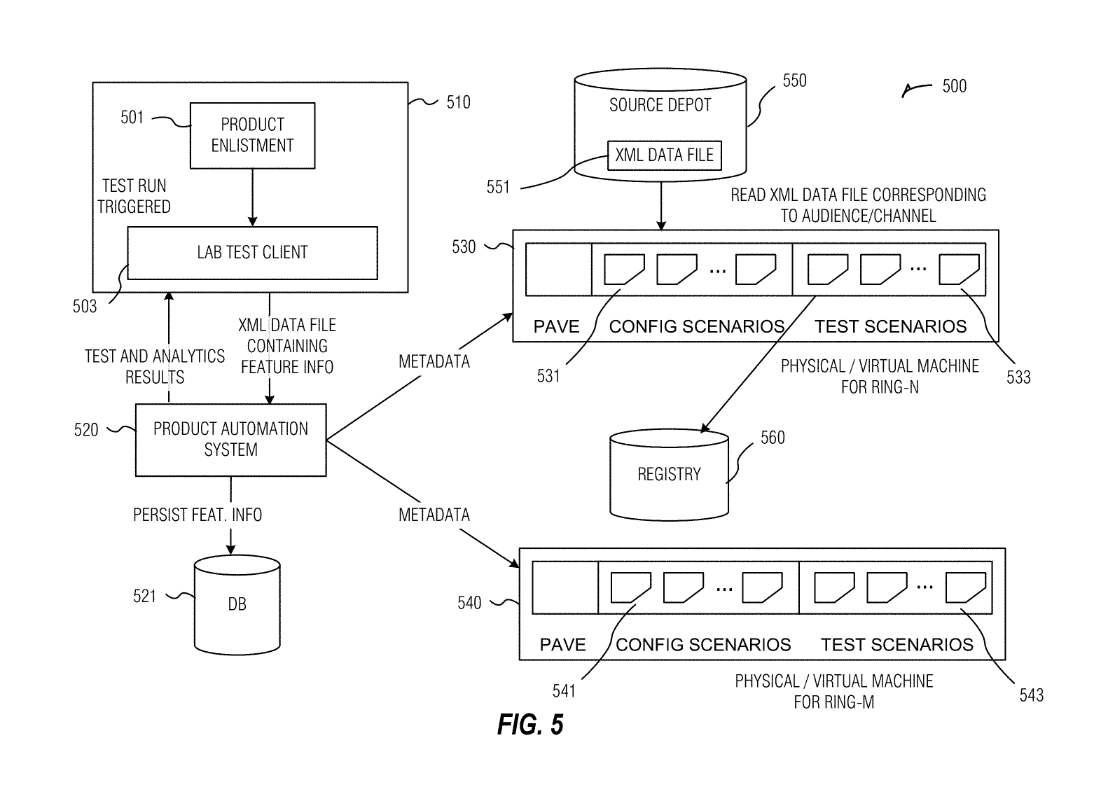

FIG. 5 is a diagram illustrating a test environment 500 for building and testing the dynamic software with audience impersonation, according to an embodiment. In an embodiment, test runs may use an automation lab for testing. An automation job may be triggered by an engineer using a tool for product enlistment, or product build tool 501 using a copy of the current codebase on a developer's workstation, by selecting an audience and channel using a command line. In an example, the command line may use syntax such as

lab_run-set “audience=AudienceValue” “channel=ChannelValue”.

The lab test client 503 on the test engineer's test platform 510 may then pass the audience information along with other metadata to a configuration build service 520 such as a product automation system, or automation service, as shorthand. In an example, the automation service is responsible for commencing a test automation job by setting up different physical and virtual machines 530, 540. The automation service 520 may be used to execute a rich variety of automated test cases in a broad range of environments. The service may manage a large set of machine resources, automated test collateral, and execution history and results. The service 520 may configure the machines 530, 540 based on the test suite that needs to be executed. The service 520 may process and store the test results and report the results back to the client 503. The service 520 may pass on the automation metadata (including the audience/channel information) to the machines 530, 540 on which the test suite may be executed. Before a test, the machines may be wiped clean of previous data and configuration information, also known as being “paved.”

Once paved, configuration scenarios 531, 541 may be executed by the machines 530, 540 to configure the machine depending on the test-suite to be executed. In an embodiment, the product applications may be installed as part of this step. The actual test scenarios 533, 543 may then be executed. As part of the setup phase for the test scenarios 533, 543, an XML file 551 from the source control system, source depot 550, corresponding to the selected audience/channel may be opened and read. Depending on the platform/architecture of the machine on which the tests are executed, the corresponding flights may be identified in the XML file 551 and then written to the registry 560, or other database, under specific application nodes, or a folder specific to an application rather than all applications. Flights may be stored in the registry under the application node for which they are applicable. For instance, if the path to the experimentation related registry settings is ../../Experiment, then the features(flights) applicable for App1 may be stored under ../../Experiment/App1 and for App2 under ../../Experiment/App2. In an example, multiple applications may be installed on a machine, and the registry may be shared across Win32 applications. Thus, the flight/feature settings may be retrieved from the application specific node when the application is launched. When the test executes, it may read the flights from the registry 560 under the node corresponding to the application for which the test is configured and the flights are used for that particular test to validate different features.

In an embodiment, a development team may select an audience for impersonation. For instance, in an example, feature A has been fully tested in audience ring-1, as shown in FIGS. 2A-2B, but many features in the test are dark, due to interoperability issues, or bugs. The team may wish to test feature A in ring-2 which has several other optional features gated on. In this example, the test team selects ring-2 as the audience, and selects feature A, with one or more treatments to be gated on in the test. If treatments T1, T2 and T3 are all selected for test, then the command line or XML file 551 may identify three sequential runs as audience ring-2, as described above. The impersonation information may be sent results of the automation test runs or retrieve the results stored in database 521 for post-test analysis.

An alternative embodiment may fetch flight information from an experimentation and control system, (ECS) for each automation run, rather than fetching the information only once for any given build, as described above. However, this alternative approach may get a different set of flights for each automation run for the same checkpoint, or build number. This may make debugging more difficult when failures occur. When the flight set is fetched only once for a given checkpoint, as part of the pre-build process, as discussed above, tracking of active flights and treatments is easier, and better for debugging.

During lab testing of the feature rollouts for the impersonated audience, the build engineer may retrieve a list of features to add to the lab test run via the XML files 551. The lab test client 503 may request the feature list and retrieve the features from a configuration management system, such as described in FIG. 3. For a baseline build (e.g., production audience), all new dynamic features may be gated off. During test, the developers may add the features for testing, which are identified in the XML file 551. In an embodiment, an XML file containing the feature information may be generated by the FetchFlights engine and stored into the codebase/Source Depot 550. The automation service 520 may read the XML file. Any persistent feature information, e.g., feature overrides specified via command-line or fetched from the XML file, may be added to database 521.

Testing may be performed on physical or virtual machines 530, 540. For instance, machines may be configured to test at different rings, or audiences, for instance the mth and nth ring, referred to generically as ring-m and ring-n. Machine 540 may be configured to test at ring-m. In an embodiment, ring-m machine 540 may be configured as the baseline device, and ring-n machine 530 may be configured to be the non-baseline machine. In an example, multiple test runs may be performed concurrently, on test machines 530 and 540. It will be understood that even though only two test machines are illustrated in FIG. 5 that more than two test machines may be present in the test environment 500. In order to test for the non-baseline segment on device 530, the device may be first wiped of old data and configuration information (e.g., paved). The configuration scenario 531, as received by the automation service 520 may be written to a data store 560 coupled to the device 530.

For devices outside of the test environment, a configuration file may be sent with the installation package/build. The end device outside of the lab may not be paved, but flight information and population segment information may be saved to a machine registry or data store coupled to the device 560. In an example, the data store used is the system registry 560. During runtime, the feature gates may access the configuration information from the registry 560 to dynamically define whether the feature is on or off. Once on/off testing is complete in a population for both baseline and non-baseline, the production team may generate a configuration list for the baseline including accepted feature rollouts. The new baseline build is generated by the configuration build system/service (e.g., automation service) 520. The deployed build includes the process code that writes the gate and e-brake configuration information to the user's data store (e.g., registry 560) so that, at runtime, the user is operationally using the baseline fork release. It should be noted that the release sent to the user may still contain the feature gates, or hooks in the code that define which features are on/off. In an embodiment, a bug fix to the user may effect a feature gate change in the installed configuration data to correct a runtime error, without actually changing the source code of the product.

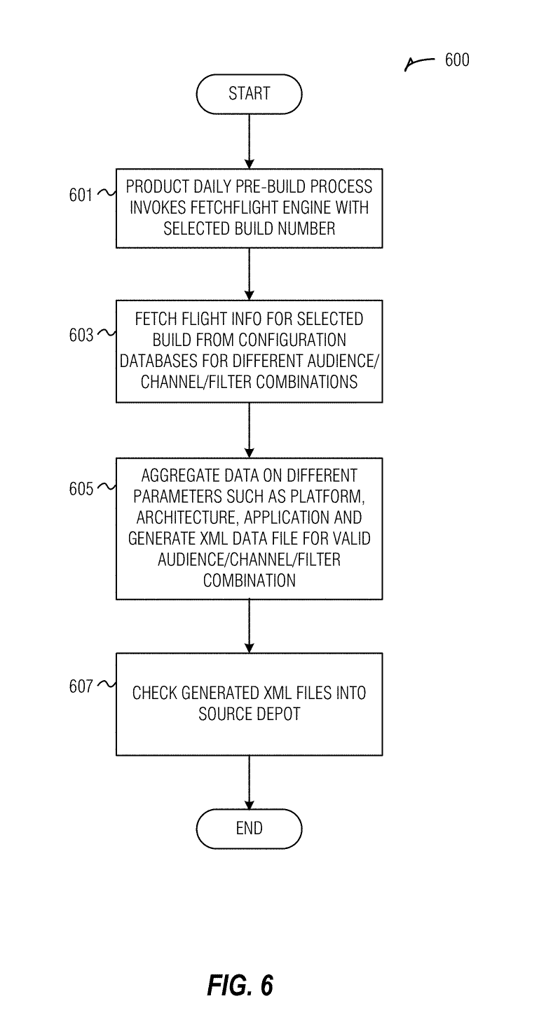

FIG. 6 is a flow chart illustrating a method 600 for building an automation test run, according to an embodiment. In an example, a product build may be re-run on a daily basis to include tested and optional or dynamic features or to exclude features that have failed testing. A pre-build process, in block 601, may invoke an engine (e.g., FetchFlights engine) to retrieve flight information based on the selected build, and audience. The pre-build process may be managed by an experimentation team. Different builds may be applied for selected audiences, with different active features, and specific to different platforms and/or operating systems. The FetchFlights engine retrieves the flight information based on the audience selected and any override information, such as feature and treatment combination tests, in block 603. The flight information may be retrieved from an experimentation and configuration system or control tower, in embodiments. The experimentation and configuration system or control tower may be services used for experimentation. A REST API may be used to fetch the flight information. A command line, XML file or Tasklib processor may be used to define the audience, channel and feature selection for the automation run. Data may be aggregated on different parameters such as platform, architecture, application and generate xml file for valid audience/channel combination, in block 605. The FetchFlights engine may generate an XML file for each valid audience/channel combination, with feature and treatment combinations, in block 607, for automation testing. The XML files generated by the FetchFlights engine may then be checked into an application source control system (e.g., source depot) as part of the pre-build process.

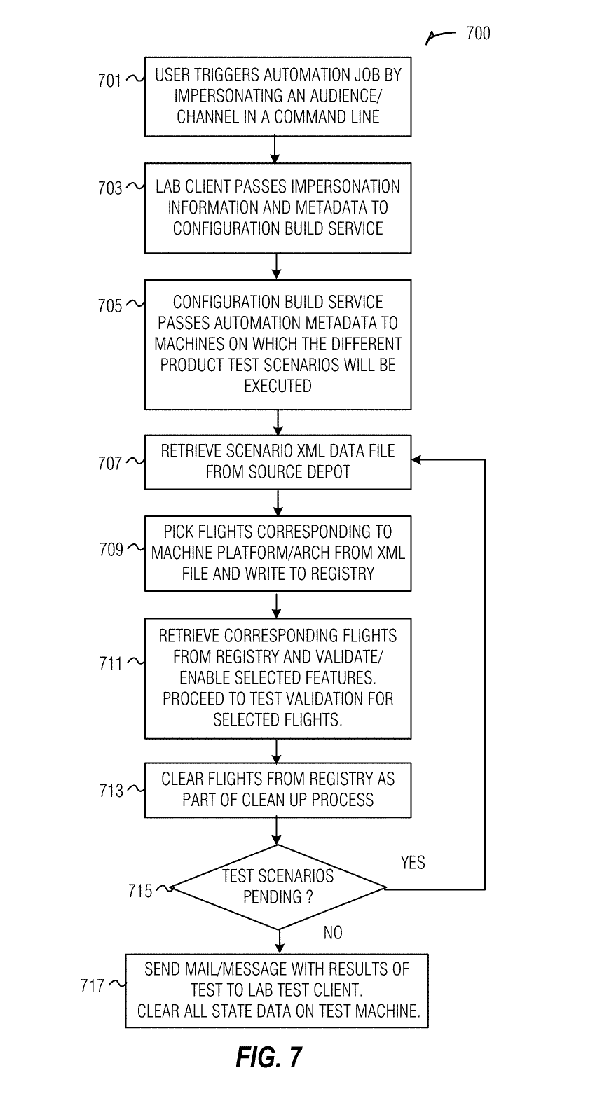

FIG. 7 is a flow diagram illustrating a method 700 for dynamically triggering an automation job by impersonating an audience, according to an embodiment. A user or test engineer, may trigger an automation job by impersonating an audience/channel in a command line, in block 701. Parameters to define the run may include a channel, such as development or production, and an audience or ring. The audience may be specified as ring-1 to ring-4 as discussed above, or as an automation audience, or no-feature-rollout audience, or full production deployment audience, etc. When an audience is specified, configurations marked for the specified audience group and all audience rings outside of the group may be fetched. Parameters may include application flights or team flights. An application flight, for instance, may filter the features applied to only include those that have been configured for a specific application in the experimentation and configuration system. In an example, if the parameter is not set, flights for all applications may be fetched. In an example, a team flight parameter may be used to filter flights based on the flight name, based on the development team. Various default cases, for instance, when a parameter is blank or missing, or undefined, may be pre-defined and stored in the experimentation and configuration system.

Once selected by command line, the lab test client passes the audience impersonation information and metadata, such as build version number, architecture, platform, etc. to the configuration build service, such as automation service, in block 703. The configuration build service is the service responsible for kicking off an automation job by setting up different physical and virtual machines configured based on the test suite that needs to be executed. The configuration build service passes the automation metadata to one or more physical or virtual machines on which the product test scenarios are to be executed, in block 705. A scenario XML file may be retrieved from the source depot, in block 707. The scenarios define what is to be tested for the audience, and optional flights. The flights corresponding to the audience, build and configuration defined in the XML file are picked and written to a database accessible by the test machine, such as in the system registry, in block 709.

Corresponding flights from the database/registry may be retrieved and selected features are validated and enabled, for the test run, in block 711. Test validation for the impersonated audience may then be performed for the selected flights. Once the testing is completed, the flights may be cleared from the registry as part of the clean-up process, in block 713. A determination is made in block 715 as to whether additional test scenarios are pending. When feature/treatment combinations are identified, multiple test information may be entered into the same configuration file, or a separate file for each test scenario may be generated. The process for setting configurations, wiping state data from the machine and configuring the machine for the next test scenario continues until all identified test scenarios have been performed. When all there are more test scenarios pending, processing continues in block 707 to retrieve the next test scenario file.

When test scenarios are complete, electronic mail or other message may be sent to the lab test client with the results of the test, in block 717. In an embodiment, all of the specifics of the test run outcomes are stored in a database managed by the automation service. The user who started the test may receive an email summary of what passed and what failed during the run. The email with test results may be sent to the user who triggered the job. The automation job results may also be retrieved by directly accessing the automation service portal. The results may be accessible for several days, or other period, based on storage space. In an example, the email information may categorize failures into three groups: new failures; untracked failures; and existing bugs. The email may also provide pointers into the bug history (e.g., in case of existing bug), and steps for investigating. The email may also include a link to a folder that has all of the logs generated during the automation run. Once the automation run results have been stored and user(s) notified, all state data on the test machines may be cleared in preparation for the next test.

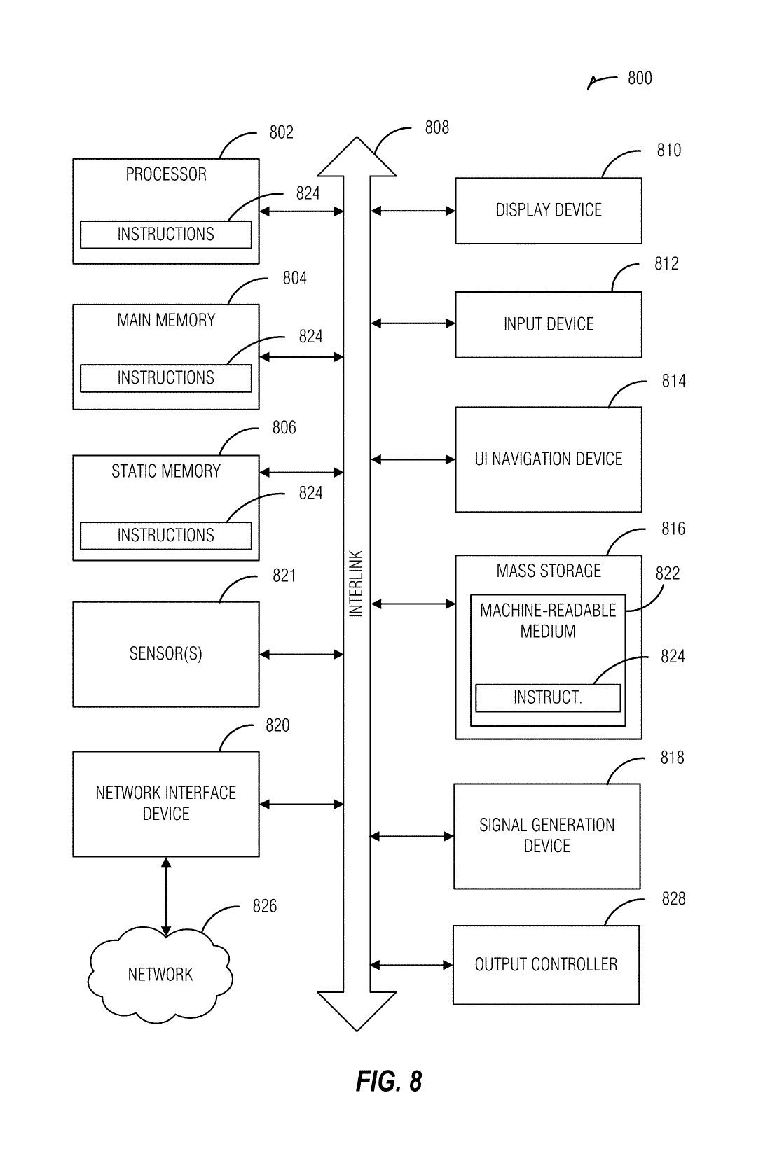

FIG. 8 illustrates a diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes and Examples

Examples may include subject matter such as a method, means for performing acts of the method, at least one machine-readable medium including instructions that, when performed by a machine cause the machine to performs acts of the method, or of an apparatus or system for impersonating an audience in an automation test run, according to embodiments and examples described herein.

Example 1 is a computer implemented method for impersonating an audience in test automation, comprising: receiving selected impersonation audience, build, and channel identifiers for a software application build in a user request for test automation; retrieving test run information for the software application build, the test run information associated with the selected build, impersonation audience and channel identifiers; identifying static features to apply to the software application build, the static features being identified in a configuration database and associated with the selected impersonation audience identifier; responsive to the user request, identifying an optional feature to apply to the software application build; generating a data file that identifies test parameters associated with a target platform and architecture associated with the software application build, the selected impersonation audience, and the optional feature; storing the data file in a data store accessible by a configuration build service; initiating configuration of a test machine with the test parameters in the data file, by the configuration build service; and initiating a test automation run with the test parameters in the data file on the configured test machine.

In Example 2, the subject matter of Example 1 optionally includes wherein configuration of the test machine includes storing information related to the optional feature in a database accessible by the test machine during the test automation run, the information related to the optional feature enabling the optional feature to be dynamically configured during runtime.

In Example 3, the subject matter of Example 2 optionally includes wherein application code for the optional feature in the software application build includes a feature gate to manage the optional feature based on the test parameters associated with the optional feature and the selected audience stored in the database accessible by the test machine during the test automation run.

In Example 4, the subject matter of Example 3 optionally includes wherein the test parameters associated with the optional feature and the selected audience identify whether the optional feature is one of enabled and disabled, and whether one or more treatments are associated with the optional feature.

In Example 5, the subject matter of any one or more of Examples 1-4 optionally include initiating an additional test run on the configured test machine when the data file indicates an additional test scenario.

In Example 6, the subject matter of Example 5 optionally includes wherein test the parameters associated with the software application build and the optional feature include identification of at least one treatment corresponding to the optional feature, wherein each combination of the optional feature with each at least one treatment results in an additional test scenario.

In Example 7, the subject matter of any one or more of Examples 1-6 optionally include wherein the configuration of the test machine includes clearing the test machine of state and other data before the configuring the test machine with the parameters in the data file.

In Example 8, the subject matter of any one or more of Examples 1-7 optionally include storing results from the automated test run in a data store accessible for analysis after the automated test run is completed.

Example 9 is a computer readable storage medium having instructions stored thereon, the instructions when executed on a machine cause the machine to: receive selected impersonation audience, build, and channel identifiers for a software application build in a user request for test automation; retrieve test run information for the software application build, the test run information associated with the selected build, impersonation audience and channel identifiers; identify static features to apply to the software application build, the static features being identified in a configuration database and associated with the selected impersonation audience identifier; responsive to the user request, identify an optional feature to apply to the software application build; generate a data file that identifies test parameters associated with a target platform and architecture associated with the software application build, the selected impersonation audience, and the optional feature; store the data file in a data store accessible by a configuration build service; initiate configuration of a test machine with the test parameters in the data file, by the configuration build service; and initiate a test automation run with the test parameters in the data file on the configured test machine.

In Example 10, the subject matter of Example 9 optionally includes wherein configuration of the test machine includes storing information related to the optional feature in a database accessible by the test machine during the test automation run, the information related to the optional feature enabling the optional feature to be dynamically configured during runtime.

In Example 11, the subject matter of Example 10 optionally includes wherein application code for the optional feature in the software application build includes a feature gate to manage the optional feature based on the test parameters associated with the optional feature and the selected audience stored in the database accessible by the test machine during the test automation run.

In Example 12, the subject matter of Example 11 optionally includes wherein the test parameters associated with the optional feature and the selected audience identify whether the optional feature is one of enabled and disabled, and whether one or more treatments are associated with the optional feature.

In Example 13, the subject matter of any one or more of Examples 9-12 optionally include instructions to initiate an additional test run on the configured test machine when the data file indicates an additional test scenario.

In Example 14, the subject matter of Example 13 optionally includes wherein test the parameters associated with the software application build and the optional feature include identification of at least one treatment corresponding to the optional feature, wherein each combination of the optional feature with each at least one treatment results in an additional test scenario.

In Example 15, the subject matter of any one or more of Examples 9-14 optionally include wherein the configuration of the test machine includes clearing the test machine of state and other data before the configuring the test machine with the parameters in the data file.

In Example 16, the subject matter of any one or more of Examples 9-15 optionally include storing results from the automated test run in a data store accessible for analysis after the automated test run is completed.

Example 17 is a system for automation testing of a software build according to an audience impersonation, comprising: a processor to execute automation build logic, the automation build logic configured to: receive selected audience, build, and channel identifiers for a software build; generate the software build for an automation test using build configuration information to identify static features associated with the selected audience and an optional feature for inclusion in the software build, wherein the static features are dependent on feature configuration information in a configuration database communicatively coupled to the processor; and generate at least one test scenario for the software build; and a build configuration data store communicatively coupled to the processor, the build configuration data store storing a data file that identifies test parameters associated with a target platform, architecture, the software build, selected audience, and the optional feature, wherein the test scenario includes at least one test run having a predefined combinations of features, as defined in the feature configuration information.

In Example 18, the subject matter of Example 17 optionally includes wherein each combination of features in the predefined combinations of features is associated with a feature and at least one treatment associated with the feature, wherein the feature is enabled or disabled according to the feature configuration information and corresponding information configured to be stored in a test machine database accessible during the at least one test run, and wherein optional features not associated with the selected audience are disabled in the software build.

In Example 19, the subject matter of Example 18 optionally includes wherein the test machine database storing the corresponding information comprises a system registry coupled to the test machine.

In Example 20, the subject matter of any one or more of Examples 18-19 optionally include wherein corresponding information is stored in an emulated system registry coupled to the test machine.

In Example 21, the subject matter of any one or more of Examples 18-20 optionally include a data store to store results of the at least one test run, the data store accessible to an experimentation team after the at least one test run is complete.

In Example 22, the subject matter of any one or more of Examples 17-21 optionally include wherein application code for the at least one optional feature in the software build includes a feature gate to manage the optional feature based on the parameters associated with the optional feature and the selected audience.

In Example 23, the subject matter of Example 22 optionally includes wherein the feature gate exposes the optional feature using an application program interface protocol.

Example 24 is a system configured to perform operations of any one or more of Examples 1-23.

Example 25 is a method for performing operations of any one or more of Examples 1-23.

Example 26 is a machine readable medium including instructions that, when executed by a machine cause the machine to perform the operations of any one or more of Examples 1-23.

Example 27 is a system comprising means for performing the operations of any one or more of Examples 1-23.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A computer implemented method for impersonating an audience in test automation, comprising:
receiving selected impersonation audience, build, and channel identifiers for a software application build in a user request for test automation;
retrieving test run information for the software application build, the test run information associated with the selected build, impersonation audience and channel identifiers;
identifying static features to apply to the software application build, the static features being identified in a configuration database and associated with the selected impersonation audience identifier;
responsive to the user request, identifying an optional feature to apply to the software application build;
generating a data file that identifies test parameters associated with a target platform and architecture associated with the software application build, the selected impersonation audience, and the optional feature;
storing the data file in a data store accessible by a configuration build service;
initiating configuration of a test machine with the test parameters in the data file, by the configuration build service; and
initiating a test automation run with the test parameters in the data file on the configured test machine.

2. The computer implemented method as recited in claim 1, wherein configuration of the test machine includes storing information related to the optional feature in a database accessible by the test machine during the test automation run, the information related to the optional feature enabling the optional feature to be dynamically configured during runtime.

3. The computer implemented method as recited in claim 2, wherein application code for the optional feature in the software application build includes a feature gate to manage the optional feature based on the test parameters associated with the optional feature and the selected audience stored in the database accessible by the test machine during the test automation run.

4. The computer implemented method as recited in claim 3, wherein the test parameters associated with the optional feature and the selected audience identify whether the optional feature is one of enabled and disabled, and whether one or more treatments are associated with the optional feature.

5. The computer implemented method as recited in claim 1, further comprising:
initiating an additional test run on the configured test machine when the data file indicates an additional test scenario.

6. The computer implemented method as recited in claim 5, wherein test the parameters associated with the software application build and the optional feature include identification of at least one treatment corresponding to the optional feature, wherein each combination of the optional feature with each at least one treatment results in an additional test scenario.

7. The computer implemented method as recited in claim 1, wherein the configuration of the test machine includes clearing the test machine of state and other data before the configuring the test machine with the parameters in the data file.

8. The computer implemented method as recited in claim 1, further comprising storing results from the automated test run in a data store accessible for analysis after the automated test run is completed.

9. A computer readable storage medium having instructions stored thereon, the instructions when executed on a machine cause the machine to:
receive selected impersonation audience, build, and channel identifiers for a software application build in a user request for test automation;
retrieve test run information for the software application build, the test run information associated with the selected build, impersonation audience and channel identifiers;
identify static features to apply to the software application build, the static features being identified in a configuration database and associated with the selected impersonation audience identifier;
responsive to the user request, identify an optional feature to apply to the software application build;
generate a data file that identifies test parameters associated with a target platform and architecture associated with the software application build, the selected impersonation audience, and the optional feature;
store the data file in a data store accessible by a configuration build service;
initiate configuration of a test machine with the test parameters in the data file, by the configuration build service; and
initiate a test automation run with the test parameters in the data file on the configured test machine.

10. The computer readable storage medium as recited in claim 9, wherein configuration of the test machine includes storing information related to the optional feature in a database accessible by the test machine during the test automation run, the information related to the optional feature enabling the optional feature to be dynamically configured during runtime.

11. The computer readable storage medium as recited in claim 10, wherein application code for the optional feature in the software application build includes a feature gate to manage the optional feature based on the test parameters associated with the optional feature and the selected audience stored in the database accessible by the test machine during the test automation run.

12. The computer readable storage medium as recited in claim 11, wherein the test parameters associated with the optional feature and the selected audience identify whether the optional feature is one of enabled and disabled, and whether one or more treatments are associated with the optional feature.

13. The computer readable storage medium as recited in claim 9, further comprising instructions to initiate an additional test run on the configured test machine when the data file indicates an additional test scenario.

14. The computer readable storage medium as recited in claim 13, wherein test the parameters associated with the software application build and the optional feature include identification of at least one treatment corresponding to the optional feature, wherein each combination of the optional feature with each at least one treatment results in an additional test scenario.

15. The computer readable storage medium as recited in claim 9, wherein the configuration of the test machine includes clearing the test machine of state and other data before the configuring the test machine with the parameters in the data file.

16. The computer readable storage medium as recited in claim 9, further comprising storing results from the automated test run in a data store accessible for analysis after the automated test run is completed.

17. A system for automation testing of a software build according to an audience impersonation, comprising:
a processor to execute automation build logic, the automation build logic configured to:
receive selected audience, build, and channel identifiers for a software build;
generate the software build for an automation test using build configuration information to identify static features associated with the selected audience and an optional feature for inclusion in the software build, wherein the static features are dependent on feature configuration information in a configuration database communicatively coupled to the processor; and
generate at least one test scenario for the software build; and
a build configuration data store communicatively coupled to the processor, the build configuration data store storing a data file that identifies test parameters associated with a target platform, architecture, the software build, selected audience, and the optional feature, wherein the test scenario includes at least one test run having a predefined combinations of features, as defined in the feature configuration information.

18. The system as recited in claim 17, wherein each combination of features in the predefined combinations of features is associated with a feature and at least one treatment associated with the feature, wherein the feature is enabled or disabled according to the feature configuration information and corresponding information configured to be stored in a test machine database accessible during the at least one test run, and wherein optional features not associated with the selected audience are disabled in the software build.

19. The system as recited in claim 18, wherein the test machine database storing the corresponding information comprises a system registry coupled to the test machine.

20. The system as recited in claim 18, wherein corresponding information is stored in an emulated system registry coupled to the test machine.
